(19) United States
(12) Patent Application Publication
(10) Pub. No.: US 2005/0143549 A1
(43) Pub. Date: Jun. 30, 2005

(54) Polyurethane

(75) Inventors: Renee-van Schijndel, AS Gouda (NL); Eric Appelman, Dordrecht (NL)

Correspondence Address: MAYER, BROWN, ROWE & MAW LLP, 1909 K STREET, N.W., WASHINGTON, DC, 20006, US

(73) Assignee: Unichema Chemie B.V., AA Gouda (NL)

(21) Appl. No.: 10/508,975

(22) PCT Filed: Mar. 26, 2003
(86) PCT No.: PCT/EP03/03154

(30) Foreign Application Priority Data
Mar. 28, 2002 (GB) 0207345.0

(51) Int. Cl. C08G 18/00

(52) U.S. Cl. 528/44

(57) ABSTRACT

A polyurethane obtainable by reacting a polyisocyanate, a polyester formed from a dimer fatty acid and/or dimer fatty diol, and a chain extender, wherein the polyester is additionally formed from a 1,4;3,6 dianhydrohexitol and/or the chain extender comprises a 1,4;3,6 dianhydrohexitol. The polyurethane is particularly suitable for use as a hotmelt adhesive.

### FIELD OF INVENTION

The present invention relates to a polyurethane, a process of making the polyurethane, and in particular to the use thereof as a hotmelt adhesive.

### BACKGROUND

Polyurethanes are extremely versatile materials and have been used in a wide variety of applications such as foam insulation, car seats, abrasion resistant coatings, and adhesives, particularly hotmelt adhesives.

Hotmelt adhesives are adhesives which are solid at room temperature and which are applied in the form of a melt, usually at temperatures in the range from 80 to 250° C. Cooling of the melt results in rapid physical setting of the adhesive. Some hotmelt adhesives, such as polyurethanes, can subsequently undergo a chemical reaction of functional groups present in the adhesive with moisture to form a crosslinked, infusible adhesive. It is only after this chemical curing with moisture, accompanied by an increase in the size of the molecule or crosslinking, that the adhesive acquires its final properties. The initial bond strength of the adhesive, ie before cure, is referred to as the green strength of the adhesive.

Hotmelt adhesives can be used to adhere a wide range of materials, such as polar substrates like paper, wood and metal, and low-energy substrates such as polyolefins. An obvious benefit is the absence of any solvent, which makes hot melt adhesives a technology of increasing importance.

A wide range of materials have been used as hotmelt adhesives, such as polyamides, polyesters and copolymers thereof, as well as polyurethanes. Polyurethane hotmelt adhesives have certain advantages over other materials, such as versatility in use due to low melting temperature, and good mechanical properties after curing has taken place.

Polyurethane hotmelt adhesives with high green strength are known, such as polyurethanes containing crystalline polyester polyols, but these normally suffer from other problems such as high crystallinity which results in brittleness or lack of flexibility. Alternatively, polyurethanes containing polyether may have good flexibility, but generally also have low green strength.

It is this combination of both high green strength, good adhesion and good flexibility that has been difficult to achieve with polyurethane hotmelt adhesives. Other desirable properties include thermal and hydrolytic stability, and adhesion to low-energy substrates.

### REVIEW OF THE PRIOR ART

U.S. Pat. No. 3,933,705 discloses the use of a 36 carbon dimerised fatty acid as a fatty modifier in rapid-setting polyurethanes.

U.S. Pat. No. 4,443,563 is directed to the use of 1,4:3,6 dianhydrohexitols, such as isosorbide, in polyurethane.

U.S. Pat. No. 5,994,493 is directed to the use of a polyurethane formed from an aromatic dihydroxy compound, such as bisphenol A, as a hotmelt adhesive.

### SUMMARY OF THE INVENTION

We have now surprisingly discovered a polyurethane which can be used as a hot-melt adhesive, which reduces or substantially overcomes at least one of the aforementioned problems.

Accordingly, the present invention provides a polyurethane obtainable by reacting a polyisocyanate, a polyester formed from a dimer fatty acid and/or dimer fatty diol, and a chain extender, wherein the polyester is additionally formed from a 1,4:3,6 dianhydrohexitol and/or the chain extender comprises a 1,4:3,6 dianhydrohexitol.

The invention also provides a process for preparing a polyurethane which comprises (i) reacting a polyisocyanate with a polyester formed from a dimer fatty acid and/or dimer fatty diol, to form an isocyanate-terminated prepolymer, and (ii) reacting the prepolymer with a chain extender, wherein the polyester is additionally formed from a 1,4:3,6 dianhydrohexitol and/or the chain extender comprises a 1,4:3,6 dianhydrohexitol.

The invention further provides a hotmelt adhesive comprising a polyurethane obtainable by reacting a polyisocyanate, a polyester formed from a dimer fatty acid and/or dimer fatty diol, and a chain extender, wherein the polyester is additionally formed from a 1,4:3,6 dianhydrohexitol and/or the chain extender comprises a 1,4:3,6 dianhydrohexitol.

The polyester used in the present invention is formed from, ie comprises the reaction product of, at least one dimer fatty acid and/or dimer fatty diol and/or equivalent thereof. Polyester is normally produced in a condensation reaction between at least one polycarboxylic acid and at least one polyol. Dicarboxylic acids and diols are preferred. The preferred dicarboxylic acid component of the polyester used in the present invention comprises at least one dimer fatty acid.

The term dimer fatty acid is well known in the art and refers to the dimerisation product of mono- or polyunsaturated fatty acids and/or esters thereof. Preferred dimer fatty acids are dimers of C₁₀ to C₃₀, more preferably C₁₂ to C₂₄, particularly C₁₄ to C₂₂, and especially C₁₈ alkyl chains. Suitable dimer fatty acids include the dimerisation products of oleic acid, linoleic acid, linolenic acid, palmitoleic acid, and elaidic acid. The dimerisation products of the unsaturated fatty acid mixtures obtained in the hydrolysis of natural fats and oils, e.g. sunflower oil, soybean oil, olive oil, rapeseed oil, cottonseed oil and tall oil, may also be used. Hydrogenated, for example by using a nickel catalyst, dimer fatty acids may also be employed.

In addition to the dimer fatty acids, dimerisation usually results in varying amounts of oligomeric fatty acids (so-called “trimer”) and residues of monomeric fatty acids (so-called “monomer”), or esters thereof, being present. The amount of monomer can, for example, be reduced by distillation. Particularly preferred dimer fatty acids, used to form the polyester component of the polyurethane according to the present invention, have a dicarboxylic (or dimer) content of greater than 45%, more preferably greater than 60%, particularly greater than 70%, and especially greater than 75% by weight. The trimer content is preferably less than 55%, more preferably in the range from 5 to 40%, particularly 10 to 30%, and especially 15 to 25% by weight. The monomer content is preferably less than 10%, more preferably in the range from 0.5 to 5%, particularly 1 to 4%, and especially 2 to 3% by weight. All of the above % by weight values are based on the total weight of trimer, dimer and monomer present.

The dicarboxylic acid component of the polyester preferably also comprises non-dimeric dicarboxylic acids (hereinafter referred to as non-dimeric acids). The non-dimeric acids may be aliphatic or aromatic, and include dicarboxylic acids and the esters, preferably alkyl esters, thereof, preferably linear dicarboxylic acids having terminal carboxyl groups having a carbon chain in the range from 2 to 20, more preferably 6 to 12 carbon atoms, such as adipic acid, glutaric acid, succinic acid, pimelic acid, suberic acid, azelaic acid, sebacic acid, heptane dicarboxylic acid, octane dicarboxylic acid, nonane dicarboxylic acid, decane dicarboxylic acid, undecane dicarboxylic acid, dodecane dicarboxylic acid and higher homologs thereof. Adipic acid is particularly preferred.

A monomeric dicarboxylic acid anhydride, such as phthalic anhydride, may also be employed as the or as part of the non-dimeric acid component.

The polyester is preferably formed from dimer fatty acids to non-dimer acids present at a weight ratio in the range from 10 to 100:0 to 90%, more preferably 30 to 70:30 to 70%, particularly 40 to 60:40 to 60%, and especially 45 to 55:45 to 55% by weight of the total dicarboxylic acids.

The polyol component of the polyester used in the present invention is suitably of low molecular weight, preferably in the range from 50 to 650, more preferably 70 to 200, and particularly 100 to 150. The polyol component may comprise polyols such as pentaerythritol, triols such as glycerol and trimethylolpropane, and preferably diols. Suitable diols include straight chain aliphatic diols such as ethylene glycol, diethylene glycol, 1,3-propylene glycol, dipropylene glycol, 1,4-butylene glycol, 1,6-hexylene glycol, branched diols such as neopentyl glycol, 3-methyl pentane glycol, 1,2-propylene glycol, and cyclic diols such as 1,4-bis(hydroxymethyl)cyclohexane and (1,4-cyclohexane-dimethanol). 1,4-butylene glycol and/or 1,6-hexylene glycol are preferred, and 1,6-hexylene glycol is a particularly preferred diol.

The polyol component may also comprise a dimer fatty diol. Dimer fatty acids are mentioned above in relation to the dicarboxylic acid component, and dimer fatty diols can be produced by hydrogenation of the corresponding dimer fatty acid. The same preferences above for the dimer fatty acid apply to the corresponding dimer fatty diol component of the polyester.

The polyol component may also comprise a 1,4:3,6 dianhydrohexitol. Preferred 1,4:3,6 dianhydrohexitols are mannitol, sorbitol and iditol, which are commonly known as isomannide, isosorbide and isoidide after the relevant parent hexitol. Isosorbide (or 1,4:3,6 dianhydro-D-sorbitol) is particularly preferred. Isosorbide can be conveniently made from renewable resources such as sugars and starches, for example from D-glucose by hydrogenation followed by acid catalysed dehydration.

The polyester is preferably formed from dicarboxylic acid to diol starting materials at a molar ratio in the range from 1:1.0 to 5.0, more preferably 1:1.2 to 3.0, particularly 1:1.4 to 2.0, and especially 1:1.5 to 1.7. Thus, the diol is preferably present in molar excess so as to obtain polyester terminated at both ends with OH groups.

In a preferred embodiment, the polyester is formed from, ie comprises the reaction products of, dimer fatty acid, adipic acid, and 1,6-hexylene glycol, preferably at a molar ratio in the range from 0.01 to 1:0.1 to 1:1, more preferably 0.05 to 0.75:0.2 to 0.75:1, particularly 0.1 to 0.2:0.4 to 0.6:1, and especially approximately 0.14:0.5:1.

The polyester preferably has a molecular weight (number average) in the range from 1,000 to 6,000, more preferably 1,700 to 3,000, particularly 1,800 to 2,500, and especially 1,900 to 2,200.

The polyester preferably has a glass transition temperature (Tg) in the range from −60 to 0° C., more preferably −50 to −5° C., particularly −40 to −10° C., and especially −35 to −15° C.

The polyester preferably has a hydroxyl value (measured as described herein) in the range from 10 to 100, more preferably 30 to 80, particularly 40 to 70, and especially 50 to 60 mgKOH/g. In addition, the polyester preferably has an acid value (measured as described herein) of less than 2, more preferably less than 1.5, particularly less than 1.0, and especially less than 0.6.

The polyisocyanate component is preferably at least one isocyanate which has a functionality of at least 2, and may be an aliphatic isocyanate such as hexamethylene 1,6-diisocyanate, but more preferably is an aromatic isocyanate such as tolylene diisocyanate, m-phenylene diisocyanate, p-phenylene diisocyanate, xylylene diisocyanate, 4,4′-diphenylmethane diisocyanate, hexamethylene diisocyanate, isophorone diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, or modified compounds thereof such as uretonimine-modified compounds thereof. The polyisocyanate monomers can be used alone or as mixtures thereof. In a preferred embodiment, 4,4′-diphenylmethane diisocyanate (MDI) is used, more preferably as the only polyisocyanates employed.

In one embodiment of the invention, at least one of the aforementioned polyisocyanates is reacted with at least one of the aforementioned polyesters, to form a prepolymer.

The molar ratio of polyisocyanate to polyester starting materials which are mixed together to react to form the prepolymer is preferably in the range from 20 to 80:20 to 80%, more preferably 35 to 75:25 to 65%, particularly 45 to 70:30 to 55%, and especially 55 to 70:30 to 45%. The polyisocyanate is preferably used in molar excess relative to OH group content of the polyester, so as to obtain a reactive hotmelt containing isocyanate-terminated prepolymer and sufficient unreacted polyisocyanate, such that later addition of the chain extender can result in reaction to form the polyurethane, without the requirement for adding further polyisocyanate.

The prepolymer reaction mixture preferably has an isocyanate content (measured as described herein) in the range from 2 to 10%, more preferably 2.5 to 8%, particularly 3 to 6.5%, and especially 3.5 to 5.5% NCO.

The chain extender component used to form the polyurethane according to the present invention suitably comprises a low molecular compound having 2 or more active hydrogen groups, for example polyols such as ethylene glycol, diethylene glycol, propylene glycol, 1,4-butylene glycol, 1,5-pentylene glycol, methylpentanediol, 1,6-hexylene glycol, neopentyl glycol, trimethylolpropane, hydroquinone ether alkoxylate, resorcinol ether alkoxylate, glycerol, pentaerythritol, diglycerol, dextrose, and a 1,4:3,6 dianhydrohexitol such as isomannide, isosorbide and isoidide; aliphatic polyhydric amines such as ethylenediamine, hexamethylenediamine, and isophorone diamine; aromatic polyhydric amines such as methylene-bis(2-chloroaniline), methylenebis(dipropylaniline), diethyl-toluenediamine, trimethylene glycol di-p-aminobenzoate; alkanolamines such as diethanolamine, triethanolamine and diisopropanolamine.

In a preferred embodiment of the invention, the chain extender is a 1,4:3,6 dianhydrohexitol, more preferably isomannide, isosorbide and/or isoidide. Isosorbide is particularly preferred.

In one embodiment of the invention, at least one of the aforementioned polyesters is added together with the chain extender to react with at least one of the aforementioned prepolymers in order to form the polyurethane. The polyester employed may be the same as or different to the polyester used to form the prepolymer.

The molar ratio of chain extender to total polyester (including polyester present in the prepolymer) employed is preferably in the range from 0.1 to 10:1, more preferably 0.2 to 8:1, particularly 0.3 to 5:1, and especially 0.5 to 1.5:1.

The dimer fatty acid and/or dimer fatty diol content of the polyurethane is preferably in the range from 5 to 50%, more preferably 10 to 40%, particularly 15 to 35%, and especially 20 to 30% by weight.

The 1,4:3,6 dianhydrohexitol, preferably isosorbide, content of the polyurethane is preferably in the range from 1 to 20%, more preferably 2 to 10%, particularly 3 to 7%, and especially 3 to 5% by weight.

The molar ratio of 1,4:3,6 dianhydrohexitol, preferably isosorbide, to polyester in the polyurethane is preferably in the range from 0.2 to 2.5:1, more preferably 0.5 to 1.5:1, particularly 0.6 to 1:1, and especially 0.65 to 0.8:1.

In the present invention, the chain extender composition may optionally contain other additives such as urethane promoting catalysts, surfactants, stabilizers and pigments.

Suitable catalysts are the normal polyurethane catalysts such as compounds of divalent and tetravalent tin, more particularly the dicarboxylates of divalent tin and the dialkyl tin dicarboxylates and dialkoxylates. Examples include dibutyl tin dilaurate, dibutyl tin diacetate, dioctyl tin diacetate, dibutyl tin maleate, tin(II) octoate, tin(II) phenolate, and the acetyl acetonates of divalent and tetravalent tin. In addition, tertiary amines or amidines may also be employed, either alone or in combination with the aforementioned tin compounds. Examples of amines include tetramethyl butane diamine, bis-(dimethylaminoethyl)-ether, 1,4-diazabicyclooctane (DABCO), 1,8-diazabicyclo-(5.4.0)-undecane, 2,2′-dimorpholinodiethyl ether, dimethyl piperazine, and mixtures thereof.

Suitable surfactants include silicone surfactants such as dimethylpolysiloxane, polyoxyalkylene polyol-modified dimethylpolysiloxane and alkylene glycol-modified dimethylpolysiloxane; and anionic surfactants such as fatty acid salts, sulfuric acid ester salts, phosphoric acid ester salts and sulfonates.

Suitable stabilizers are materials which stabilize the viscosity of the polyurethane during its production, storage and application, and include monofunctional carboxylic acid chlorides, monofunctonal highly reactive isocyanates, and non-corrosive inorganic acids. Examples of such stabilizers are benzoyl chloride, toluene sulfonyl isocyanate, phosphoric acid or phosphorous acid. In addition, suitable hydrolysis stabilizers include for example the carbodiimide type.

Suitable pigments include inorganic pigments such as transition metal salts; organic pigments such as azo compounds; and carbon powder.

The polyurethane according to the present invention may be produced by simple mixing of the prepolymer and chain extender, preferably at a NCO/OH ratio in the range from 1.5 to 5:1, more preferably 1.7 to 3:1., and particularly 1.8 to 2:1.

A particular advantage of a polyurethane according to the present invention is that it has a green strength value (measured as described herein) of preferably greater than 20, more preferably greater than 50, particularly greater than 100, and especially greater than 500, and generally up to 1,000 kPa after 1 minute; and/or preferably greater than 100, more preferably greater than 200, particularly greater than 500, and especially greater than 1000, and generally up to 1,500 kPa after 5 minutes; and/or preferably greater than 200, more preferably greater than 300, particularly greater than 500, and especially greater than 1,000, and generally up to 1,500 kPa after 30 minutes.

The polyurethane suitably has a tensile strength (measured as described herein) of greater than 20, preferably in the range from 30 to 200, more preferably 40 to 150, particularly 45 to 100, and especially 50 to 80 kgcm⁻².

The elongation at break (measured as described herein) of the polyurethane is preferably greater than 150%, more preferably greater than 200%, particularly in the range from 250 to 550% and especially 300 to 400%.

One particular advantage of the polyurethane described herein is improved substrate adhesion, particularly on low energy surfaces, preferably having a surface energy of less than 50, more preferably in the range from 10 to 45, particularly 20 to 40, and especially 25 to 35 mN/m. A preferred substrate is a polyolefin such as polypropylene or polyethylene, more preferably polyethylene. Laminate structures may be formed, for example using the polyurethane of the present invention to adhere two low surface energy materials together, preferably poyolefin. Alternatively, laminates may be formed by adhering a low surface energy material to a high surface energy material. The physical form of the substrate may vary over a wide range from thin films to 3-dimensional objects.

In a particularly preferred embodiment of the invention, the polyurethane when applied as an adhesive layer on a polyolefin substrate, preferably polyethylene, suitably has an adhesive strength (measured as described herein) of greater than 200, preferably greater than 400, more preferably greater than 600, particularly greater than 800, and especially greater than 1,000, and generally up to 2,000 kPa.

The polyurethane described herein may be used as an adhesive, preferably as a hotmelt adhesive, in a wide range of applications such as woodworking and construction, shoe manufacture, in various automotive uses, and in inks, for example printed onto flexible packaging. A particularly preferred application is as an adhesive for lamination.

The hotmelt adhesives according to the invention may optionally contain tackifying resins such as, for example, abietic acid, abietic acid esters, terpene resins, terpene/phenol resins or hydrocarbon resins and also fillers (for example silicates, talcum, calcium carbonates, clays or carbon black), plasticizers such as, for example, phthalates or thixotropicizing agents (for example Bentone, pyrogenic silicas, urea derivatives, fibrillated or pulp chopped fibers) or pigment pastes or pigments.

Alternative uses of the polyurethane according to the invention include sealants, coatings and insulation materials.

The invention is illustrated by the following non-limiting examples.

In this specification, the following test methods have been used.

(a) For Polyester

(i) Molecular weight (number average) was determined by end group analysis.
(ii) The glass transition temperature (Tg) was measured by Differential Scanning Calorimetry (DSC) at a scan rate of 20° C./minute using a Mettler DSC30.
(iii) The hydroxyl value is defined as the number of mg of potassium hydroxide equivalent to the hydroxyl content of 1 g of sample, and was measured by acetylation followed by hydrolysation of excess acetic anhydride. The acetic acid formed was subsequently titrated with an ethanolic potassium hydroxide solution.
(iv) The acid value is defined as the number of mg of potassium hydroxide required to neutralise the free fatty acids in 1 g of sample, and was measured by direct titration with a standard potassium hydroxide solution.
   (b) For Prepolymer
(i) The isocyanate value is defined as the weight % content of isocyanate in the sample and was determined by reacting with excess dibutylamine, and back titrating with hydrochloric acid.
   (c) For Polyurethane
(i) Green strength was measured by melting the polyurethane onto a 100×25 mm low density polyethylene specimen, layer thickness 150 μm, followed by application of a second piece of polyethylene in a lap joint, with an overlap of 25×25 mm. Several samples (up to ten) were placed in the oven at 55° C. and removed after five minutes.

The joined polyethylene specimens were subsequently subjected to tensile tests in a Zwick tensile tester. The maximum load applied to the specimen before failure of the bond was recorded after specific time intervals of 1, 5 and 30 minutes. The increase in maximum load required illustrates the build up of green strength.
(ii) Tensile strength was determined according to ISO 37/DIN 53504 using a Z82B29 sample die. The samples were conditioned for a minimum of 24 hours, undeflected and undistorted at 23° C. and 50% relative humidity, prior to testing.
(iii) Elongation at break was measured according to ISO 37/DIN 53504 using Z82B29 sample die. The samples were conditioned for a minimum of 24 hours, undeflected and undistorted at 23° C. and 50% relative humidity, prior to testing.
(iv) Adhesive strength was determined using a lap shear bond test according to ASTM D1002 using an Instron tensile tester. Two pieces of low density polyethylene of thickness 4 mm were glued together by melting 25×25 mm of the polyurethane adhesive onto the first piece of polyethylene, followed by application of the second piece of polyethylene. The adhesive was allowed to set for 5 minutes at room temperature under light pressure, and then left for 6 days undeflected and undistorted at 23° C. and 50% relative humidity. The load at which the adhesive bond failed is the adhesive strength of the polyurethane to polyethylene.

### EXAMPLES

### Example 1

800 g of Priplast 3192 (trade mark, ex Uniqema) (polyester formed from dimer fatty acid) was charged to a reactor equipped with thermocouple, stirrer and nitrogen inlet and heated to 120° C. When the temperature had reached 120° C., vacuum was applied to 25 mbar to remove any residual water and maintained for one hour. Subsequently, the vacuum was removed and the temperature was lowered to 80° C., and 300 g of flake pure MDI (Desmodur 44, ex Bayer) was charged to the reactor and the mixture was allowed to react for 2 hours. Prior to addition of 40 g of isosorbide (ex Aldrich) as a chain extender, the temperature was increased to 120° C. One hour after addition of the isosorbide, the polyurethane was poured into a tin.

The polyurethane was subjected to the test procedures described above and the results were;
(i) The green strength of the reactive hotmelt was 100 kPa after 1 minute, 230 kPa after 5 minutes and 350 kPa after 30 minutes.
(ii) The tensile strength was 58 kgcm⁻².
(iii) The elongation at break was 300%.
(iv) The adhesive strength was 600 kPa.

### Example 2

This is a comparative example not according to the invention.

The procedure of Example 1 was repeated except that 400 g of Priplast 3192, 206 g of flake pure MDI and no isosorbide was used.

The polyurethane was subjected to the test procedures described above and the results were;
(i) The green strength of the reactive hotmelt was <10 kPa after 1, 5 and 30 minutes (and also after 60 minutes).
(ii) The tensile strength was 133 kgcm-2.
(iii) The elongation at break was 700%.
(iv) The adhesive strength was 600 kPa.

### Example 3

This is a comparative example not according to the invention.

The procedure of Example 1 was repeated except that 800 g of hexane diol adipate (Fomrez ER 196, ex Crompton) was used instead of Priplast 3192.

The polyurethane was subjected to the test procedures described above and the results were;
(i) The green strength of the reactive hotmelt was 200 kPa after 1, 5 and 30 minutes (and also after 60 minutes).
(ii) The tensile strength was 230 kgcm⁻².
(iii) The elongation at break was 190%.
(iv) The adhesive strength was 200 kPa.

The above examples illustrate the improved properties of a polyurethane according to the present invention.

1. A polyurethane obtainable by reacting a polyisocyanate, a polyester formed from a dimer fatty acid and/or dimer fatty diol, and a chain extender, wherein the polyester is additionally formed from a 1,4:3,6 dianhydrohexitol and/or the chain extender comprises a 1,4:3,6 dianhydrohexitol.

2. A polyurethane according to claim 1 wherein the chain extender comprises a 1,4:3,6 dianhydrohexitol, and optionally the polyester is additionally formed from a 1,4:3,6 dianhydrohexitol.

3. A polyurethane according to claim 1 wherein the polyester is additionally formed from a non-dimer acid, and preferably the ratio of dimer fatty acids to non-dimer acids is in the range from 30 to 70:30 to 70% by weight of the total dicarboxylic acids.

4. A polyurethane according to claim 3 wherein the non-dimer acid comprises adipic acid.

5. A polyurethane according to claim 1 wherein the polyester is formed from dimer fatty acid, adipic acid and 1,6-hexylene glycol.

6. A polyurethane according to claim 1 wherein the dimer fatty acid content of the polyurethane is in the range from 10 to 40% by weight.

7. A polyurethane according to claim 1 wherein the 1,4:3,6 dianhydrohexitol, preferably isosorbide, content of the polyurethane is in the range from 2 to 10% by weight.

8. A polyurethane according to claim 1 wherein the green strength value is greater than 50 kPa after 1 minute, and/or greater than 200 kPa after 5 minutes, and/or greater than 300 kPa after 30 minutes.

9. A polyurethane according to claim 1 wherein the tensile strength is in the range from 30 to 200 KGCM2 and/or the elongation at break is in the range from 250 to 550%.

10. A process for preparing a polyurethane which comprises (i) reacting a polyisocyanate with a polyester formed from a dimer fatty acid and/or dimer fatty diol, to form an isocyanate-terminated prepolymer, and (ii) reacting the prepolymer with a chain extender, wherein the polyester is additionally formed from a 1,4:3,6 dianhydrohexitol and/or the chain extender comprises a 1,4:3,6 dianhydrohexitol.

11. A hotmelt adhesive comprising a polyurethane obtainable by reacting a polyisocyanate, a polyester formed from a dimer fatty acid and/or dimer fatty diol, and a chain extender, wherein the polyester is additionally formed from a 1,4:3,6 dianhydrohexitol and/or the chain extender comprises a 1,4:3,6 dianhydrohexitol.
